(19) United States
(12) Patent Application Publication
(10) Pub. No.: US 2022/0383110 A1
(43) Pub. Date: Dec. 1, 2022

(54) SYSTEM AND METHOD FOR MACHINE LEARNING ARCHITECTURE WITH INVERTIBLE NEURAL NETWORKS

(71) Applicant: ROYAL BANK OF CANADA, Toronto (CA)

(72) Inventors: Michael PRZYSTUPA, Vancouver (CA); Peter FORSYTH, Waterloo (CA); Daniel RECOSKIE, Waterloo (CA); Andreas Steffen Michael LEHRMANN, Vancouver (CA)

(21) Appl. No.: 17/749,905

(22) Filed: May 20, 2022

Related U.S. Application Data
(60) Provisional application No. 63/244,924, filed on Sep. 16, 2021.
(60) Provisional application No. 63/191,408, filed on May 21, 2021.

(51) Int. Cl. G06N 3/08; G06F 17/11

(52) U.S. Cl. CPC G06N 3/08; G06F 17/11

(57) ABSTRACT

A computer system and method for predicting an output for an input are provided. The system comprises at least one processor and a memory storing instructions which when executed by the processor configure the processor to perform the method. The method comprises at least one of estimating a posterior for a plurality of inputs and associated outputs, or providing a point estimate without sampling. The method also comprises predicting the output for a new observation input.

### CROSS-REFERENCE

This application is related to and claims priority to U.S. Application No. 63/191,408, entitled System And Method For Machine Learning Architecture with Invertible Neural Networks, and filed 21 May 2021.

This application is also related to and claims priority to U.S. Application No. 63/244,924, entitled System And Method For Machine Learning Architecture with Invertible Neural Networks, and filed 16 Sep. 2021.

### FIELD

The present disclosure relates generally to machine learning, and in particular to a system and method for machine learning architecture with invertible neural networks.

### INTRODUCTION

Resolving uncertainty in the context of inverse problems is a challenging task. Many inverse problems are ill-posed due to the non-injectivity of the forward mapping, or the poor conditioning of the inverse mapping. Invertible neural networks (INNs) address this problem by modeling the posterior of the unknown data conditional on the known data. Previously, INNs have been applied to solve inverse problems across scientific domains including robotic kinematics, medicine, and physics. Recent research has aggregated multiple forward observations to reduce uncertainty. Typical state-of-the-art methods assume that the forward process is trivial to evaluate, and model only the inverse problem.

However, in applications, the assumption of easily computed forward processes does not always hold, such as when Monte Carlo simulation is required. A number of works approximate these expensive simulations with deep learning models. So far, there is limited work understanding the capacity of INNs for accurately and simultaneously modeling forward and inverse processes. Even when trained to model forward and inverse processes, current INNs cannot associate an arbitrary number of forward predictions with a shared inverse solution.

### SUMMARY

A deep learning framework is proposed that resolves uncertainty of ill-posed inverse problems while maintaining the capacity for forward prediction. The proposed model improves upon alternative methods for both forward prediction and in representing the posterior distribution. The proposed framework is modular; it does not focus on optimizing any single component, instead focusing on addressing the core challenges in the problem space as well as training INNs for this task.

In one embodiment, there is provided a system for predicting an output for an input. The system comprises at least one processor and a memory storing instructions which when executed by the processor configure the processor to at least one of estimate a posterior for a plurality of inputs and associated outputs, or provide a point estimate without sampling. The processor is also configured to predict the output for a new observation input.

In another embodiment, there is provided a method of predicting an output for an input. The method comprises at least one of estimating a posterior for a plurality of inputs and associated outputs, or providing a point estimate without sampling. The method also comprises predicting the output for a new observation input.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIG. 1 illustrates a visualization of an example of the problem addressed in the teachings herein;

FIG. 2 illustrates, in a schematic diagram, an example of a machine learning prediction platform, in accordance with some embodiments;

FIG. 3 illustrates an overview of an example of a forward and inverse prediction framework, in accordance with some embodiments;

FIG. 4 illustrates, in a schematic diagram, an example of a method of prediction an output for an input, in accordance with some embodiments;

FIGS. 5A to 5C illustrate, in graphs, a change in R2 metric as more data is collected for the proposed system compared to baselines, in accordance with some embodiments; and

FIG. 6 is a schematic diagram of a computing device such as a server.

It is understood that throughout the description and figures, like features are identified by like reference numerals.

### DETAILED DESCRIPTION

Embodiments of methods, systems, and apparatus are described through reference to the drawings.

Invertible neural networks have been successfully applied for the purpose of posterior distribution estimation for inverse problems in a variety of scientific fields. However, there is limited work on resolving uncertainty in the inverse posterior, or exploiting an invertible neural network's capacity for forward prediction. A novel neural network architecture is proposed herein. In addition to jointly modeling both the inverse problem of interest and the associated forward problem, the architecture can aggregate multiple observations to resolve uncertainty. In an exemplary context, the model is evaluated in the context of computational finance where fast, robust inverse and forward prediction are critical for real world application. The model performs favourably compared to separately trained models for each task, and the model's ability to aggregate information decreases uncertainty of the inverse solution posterior.

Given the challenges expensive forward simulation can incur and the value of modelling inverse solution uncertainty, proposed herein is a model that: (1) can handle an arbitrary number of inputs and outputs to help reduce uncertainty in the set of possible inverse solutions; (2) provides a means of choosing a point estimate inverse solution without sampling, because of the cost of iterative evaluation; (3) is able to utilize the chosen inverse solutions for future parallel conditional forward predictions. One could train separate models to satisfy each criterion. However, theoretical results suggest that INNs are powerful function approximators and practical knowledge about INN training has advanced considerably. Empirically, recent benchmarking work suggest that INNs are particularly effective at modelling uncertainty in inverse problems. Since INNs use one model, each prediction is consistent with its inverse. Using different models could introduce inconsistencies with the inverses.

A single (machine learning) network architecture is proposed that can simultaneously model the forward process and inverse process with an arbitrary number of associated inputs and outputs. The (machine learning) model learns to summarize pertinent information with summary embeddings. Because the proposed INN is volume-preserving, it can produce efficient point estimates. The model can be trained with a composite loss including maximum likelihood training and regularization terms to encourage robustness in both directions. The proposed framework was analyzed in the context of computational finance, where rapid decision making for inverse and forward prediction are required.

To summarise, in some embodiments, the following contributions are made:
a modular end-to-end INN framework capable of forward and inverse prediction with multiple observations;
volume-preserving transformations are used to enable efficient MAP (Maximum a Posteriori) estimation. Adverse effects of volume-preserving transformations on the inverse posterior may be mitigated with a bi-directional regularizer.
INNs are applied in the context of financial derivative calibration and pricing. Previously, this is a domain where standard neural networks have been applied. The invertible nature of the INNs provides the benefit of consistency between predictions and their inverse functions.

A description of the problem sought to be address, and relevant components in the proposed neural architecture, will now be described. An aspect of the proposed framework is jointly modelling both forward and inverse processes in order to resolve uncertainty and make future predictions. Throughout this description, bold lower case will be used for vectors (x, y), bold upper case for matrices (X, Y), and non-bold upper case letters for random variables (X, Z). In particular, Z represents a latent random variable, and subscripts on Z correspond to latent representations (Z_{X}, Z_{Y}). ρ_{X}(x) is the probability of given sample x under the distribution of random variable X.

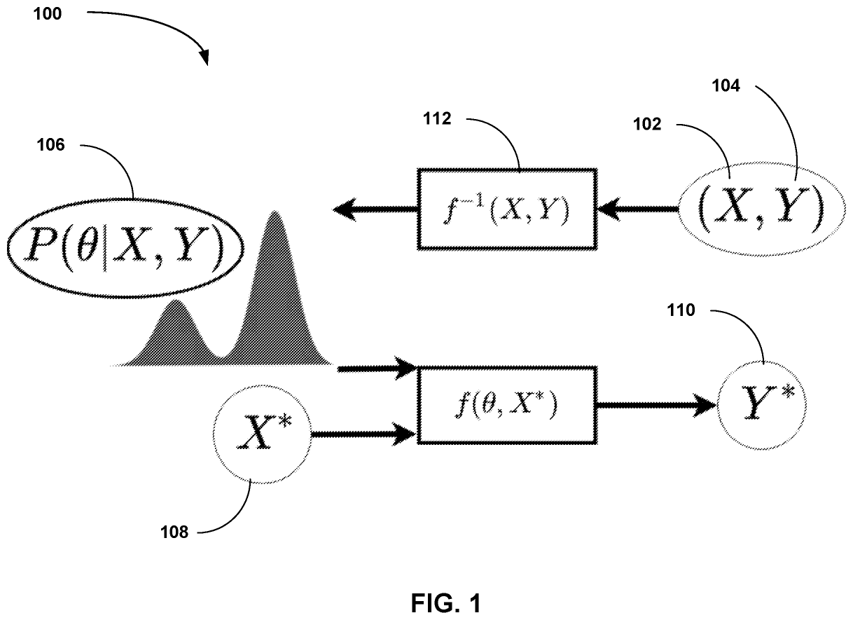

FIG. 1 illustrates a visualization 100 of an example of the problem addressed in the teachings herein. Given input 102 and output data 104, a posterior 106 of parameters is to be estimated explaining the data, and then the posterior 106 is used to predict new output observations 110 for new input data 108. Input 102 and output 104 data are used to determine an inverse function 112 that determines the posterior 106.

Let θ∈Θ⊂ [symbol] ^{m} denote the unknown state of nature, let {xᵢ}ᵢ₌₁^{T}⊂ [symbol] ⊂ [symbol] ^{d} denote the input observations, and let {yᵢ}ᵢ₌₁^{T}⊂ [symbol] ⊂ [symbol] ⁿ denote the corresponding output. Assume that a known, function ƒ: x×Θ→ [symbol] associates each input with the corresponding output. The function ƒ may be non-deterministic because of system noise. In other words, the observations, Y∈ [symbol] ^{T×n}, are of the form Y=Y*+ϵ, where ϵ˜N(0, σ1) for some scalar σ∈ [symbol] ⁺, and Y⁺ is the true value. The aims are:
1. to estimate a distribution of θ from {xᵢ}ᵢ₌₁^{T} and {yᵢ}ᵢ₌₁^{T}, and
2. to use this distribution of θ to predict the y′∈ [symbol] corresponding to a previously unseen x′∈ [symbol] .

A trivial example of this problem is linear regression, where θ is the set of weights w defining the relation Xw=Y. As more data is collected, the set of possible weights w should decrease under the model. The problem is more interesting with non-linear mappings where the INN needs to learn complex nonlinear behavior.

It is also assumed that there is limited time for utilizing the distribution of p(θ|X,Y). Therefore, having the full posterior of θ is a valuable feature, as is having a good point estimate of θ, in view of the limited temporal nature for utilizing the distribution. I.e., determining the full posterior of θ in a timely manner allows for the timely utilization of the distribution in order to obtain improved predictions, in a manner that provides significant improvement over the state of the art.

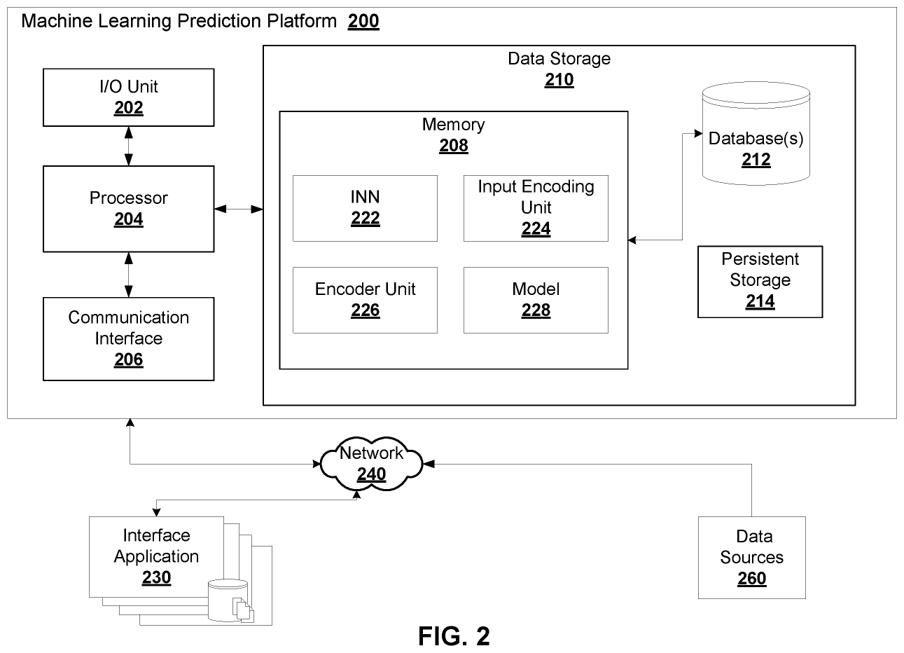

FIG. 2 illustrates, in a schematic diagram, an example of a machine learning prediction platform 200, in accordance with some embodiments. The platform 200 may be an electronic device connected to interface application 230 and data sources 260 via network 240. The platform 200 can implement aspects of the processes described herein.

The platform 200 may include a processor 204 and a memory 208 storing machine executable instructions to configure the processor 204 to receive a voice and/or text files (e.g., from I/O unit 202 or from data sources 260). The platform 200 can include an I/O Unit 202, communication interface 206, and data storage 210. The processor 204 can execute instructions in memory 208 to implement aspects of processes described herein.

The platform 200 may be implemented on an electronic device and can include an I/O unit 202, a processor 204, a communication interface 206, and a data storage 210. The platform 200 can connect with one or more interface applications 230 or data sources 260. This connection may be over a network 240 (or multiple networks). The platform 200 may receive and transmit data from one or more of these via I/O unit 202. When data is received, I/O unit 202 transmits the data to processor 204.

The I/O unit 202 can enable the platform 200 to interconnect with one or more input devices, such as a keyboard, mouse, camera, touch screen and a microphone, and/or with one or more output devices such as a display screen and a speaker.

The processor 204 can be, for example, any type of general-purpose microprocessor or microcontroller, a digital signal processing (DSP) processor, an integrated circuit, a field programmable gate array (FPGA), a reconfigurable processor, or any combination thereof.

The data storage 210 can include memory 208, database(s) 212 and persistent storage 214. Memory 208 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 210 can include memory 208, databases 212 (e.g., graph database), and persistent storage 214.

The communication interface 206 can enable the platform 200 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these.

The platform 200 can be operable to register and authenticate users (using a login, unique identifier, and password for example) prior to providing access to applications, a local network, network resources, other networks and network security devices. The platform 200 can connect to different machines or entities.

The data storage 210 may be configured to store information associated with or created by the platform 200. Storage 210 and/or persistent storage 214 may be provided using various types of storage technologies, such as solid state drives, hard disk drives, flash memory, and may be stored in various formats, such as relational databases, non-relational databases, flat files, spreadsheets, extended markup files, etc.

The memory 208 may include an inverse neural network (INN) 222, an input encoding unit 224, an encoding unit 226, and a model 228.

### Invertible Neural Network Components

INNs are typically applied to normalizing flows for generative modelling. An advantage of normalizing flows is that they allow for direct optimization of the marginal probability of the data distribution through the change-of-variable theorem. This means that the probability of data X can be rewritten as a series of deterministic invertible transformations from some base distribution p_{Z}(z) as p_{X}(x)=p_{Z}(z)|det J_{x→z}|⁻¹, where

$${J}_{x \to z} = \frac{δ f ( x )}{δ x}$$

is the Jacobian matrix. By stacking invertible transformations ƒᵢ, one can generate data samples by inverting the transformations on samples from the base distribution: x=ƒₙ⁻¹∘θₙ₋₁⁻¹∘ƒₙ₋₂⁻¹ . . . ∘ƒ₁⁻¹(z) where z˜p_{Z}(z). When doing maximum likelihood training, normalizing flow models optimize the log-probability of the distribution:

$$log {p}_{X} ( x ) = \frac{1}{2} {‖ z ‖}_{2}^{2} - log \vert det {J}_{x \to z} \vert \qquad ( 1 )$$

Affine Coupling Layers. A typical choice of invertible transformations is the affine coupling block which performs a scale and shift operation on a provided input. An affine coupling layer similar to ReaINVP coupling layers may be used, which splits an input vector into to partitions x=[u₁, u₂] which are transformed via:

v₁=u₁⊙exp(log s₂(u₂))+t₂(u₂) (2)

v₂=u₂⊙exp(log s₁(v₁))+t₁(v₁), (3)

where ⊙ is an element-wise operation, and logsᵢ(x)=wᵢ⊙ tanh(ƒ_{θ}(x)), where ƒ_{θ}(x) is a neural network. Scaling vectors [w₁, w₂] are learned, independent weights, that along with the tanh operation are a form of soft clamping for numerical stability.

Maximum likelihood for Invertible Neural Networks A variety of loss functions have been used to train invertible neural networks. Many authors directly optimize the mean squared error of the forward process with a maximum mean discrepancy (MMD) regularizer, or use Equation (1) to optimize only the inverse direction. Herein, the maximum likelihood is uses as it was found to be computationally efficient and stable. This is a modified version of the normalizing flow objective in Equation (1), where the base distribution is assumed to include the forward model prediction:

$$log {p}_{Θ} ( θ \vert Y ) = λ {‖ {Y}^{*} - \hat{Y} ‖}_{2}^{2} + \frac{1}{2} {‖ z ‖}_{2}^{2} - \frac{1}{{s}_{z}} log \vert det {J}_{θ \to ( z , Y )} \vert . \qquad ( 4 )$$

where ∥⋅∥₂ denotes the L2 norm, and A denotes the INN's prediction. By training the model to predict Y, the INN learns to model the forward and inverse processes. Here, the latent variable Z encodes the ambiguity due to non-injectivity and noise in the forward processes, and s_{Z} is the dimension of the latent space. Z may be constrained to be from a unit Gaussian. The weight, λ, controls the trade-off between how close Z follows the base distribution, and how well the model reconstructs the observations.

A challenge with modelling inverse problems in this bi-directional fashion is that invertible neural networks assume a bijectivity. To allow non-bijectivity, padding may be used, either with zeros or samples from a random variable.

### Methodology

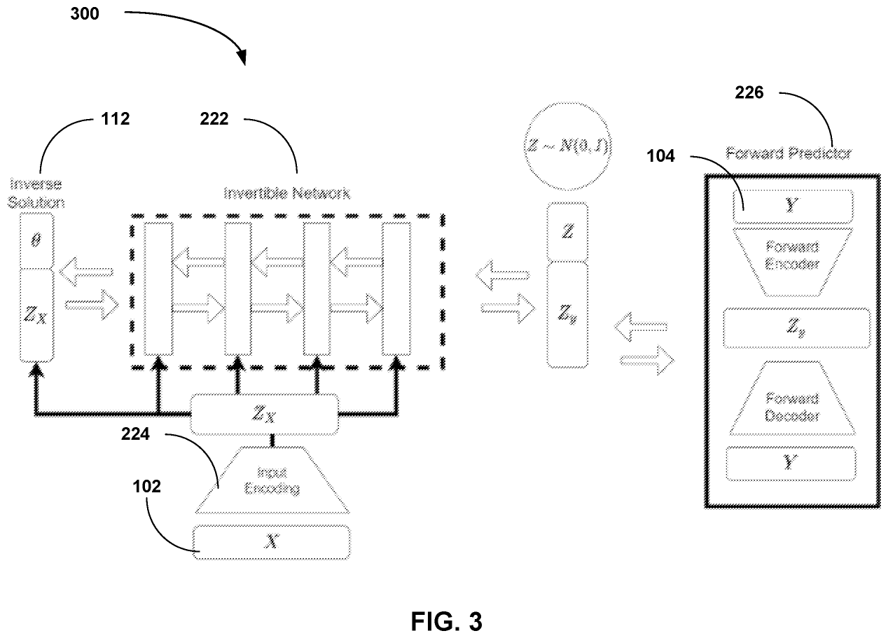

An INN framework to address the problem above will now be described. FIG. 3 shows an example of a modified INN framework 222. The summary modules that enable the networks to handle an arbitrary number of inputs and outputs will be discussed. Then, the modified INN module 222 and the modifications necessary to interface with summary modules will be described. How to optimize the model 228 so that it is robust in both resolving uncertainty and forward prediction will also be described.

FIG. 3 illustrates an overview of an example of a forward and inverse prediction framework 300, in accordance with some embodiments. By combining appropriate components to summarize pertinent information for both forward prediction and inverse prediction the framework 300 may be applied to not only find inverse solutions 112 but then use the solutions to make forward predictions. By aggregating multiple observations, the network 222 can reduce uncertainty in the inverse problem.

### Summarizing Information

A first challenge is to summarize inputs X 102 and outputs Y 104. In some embodiments, one approach uses summary networks for representing complex data with conditional INNs, but differs as it is also desired to reconstruct the data from the summary representation.

Although the data may not be sequential, its correspondence is maintained between each input and output. This means a model 228 that is sensitive to order is used. Bidirectional gated recurrent units may be used for encoding both inputs and outputs. These models provide summary representation g_{ϕ}(X)=zₓ∈ [symbol] ^{s}^{ₓ} and g_{ϕ′}(Y)=Z_{Y}∈ [symbol] ^{s}^{_{y}}.

### Invertible Forward and Inverse Predictor

With the summarized representations, the invertible neural architecture 222 at the core of the proposed model will now be discussed. The INN 222 is to accomplish three tasks: (1) estimating a posterior P(θ|X,Y) 106, (2) providing a point estimate θ* without sampling, and (3) predicting y′ 110 when provided new observations x′ 108 associated with a chosen point estimate. In some embodiments, affine coupling layers may be used where the affine parameters are produced by a shared hyper-networks (sᵢ(u,zₓ), tᵢ(u,zₓ))=g_{ϕ″}(u,zₓ), but otherwise follow the ReaINVP design. Training a single hypernetwork per layer provides an inductive bias.

The first task, estimating a posterior, is handled by the inclusion of a latent variable Z of dimension s_{z}. A difference in the proposed framework is that the inputs X 102 are included as conditional information to each affine coupling layer as shown in FIG. 3. To address a mismatch between m (the dimension of θ) and s_{y}+s_{z} (the dimension of z_{y} plus the dimension of Z) zero-padding may be used.

To address the second task, producing a point estimate, the maximum a posteriori estimate θ* may be used. When a transformation is volume persevering, the maximum a posteriori estimate of a transformed distribution is the transformation applied to the point of maximum density of the base distribution. If the proposed INN 222 is volume-preserving, then p(x)=p(z)|Jₓ|=p(z) because |Jₓ|=1 (i.e. the modes correspond). In some embodiments, affine coupling layers are made volume persevering by subtracting the arithmetic mean of scaling parameter

$$\overline{s} ( x ) = \frac{1}{m} {\sum }_{i}^{m} log {s}^{i} ( x , {z}_{x} )$$

where m is the dimensions of the coupling layer. Note: Subtracting the arithmetic mean causes the Jacobian to be one when scaling is the exponential function. It can be derived from the following identity of determinants

$$\frac{1}{det A} det A = det ( A \frac{1}{det {A}^{1} / n} )$$

and rules of exponential e^{a}e^{-b}=e^{a-b}. This leads to the following reformulation of the coupling layers:

v₁=u₁⊙exp(logs₂(u₂,z_{X})−s̅₂(u₂)+t₂(u₂,z_{X}), (5)

v₂=u₂⊙exp(logs₁(v₁,z_{X})−s̅₁(v₁)+t₁(v₁,z_{X}). (6)

For fast inference, the MAP as described above may be used. It should be noted that the MAP is not always the optimal point estimate, but in practice it works well.

### Training The System

The proposed network 222 has a number of components that are to be trained. The following objective is proposed:

L(z,z_{Y},X,Y,Ŷ,θ)=−log p(θ;z_{X}|X,Y)+L_{y}(Ŷ,Y)+L_{reg}(θ,z,X,z) (7)

The first term

−log p(θ;z_{X}|X,Y)=∥z∥₂²+ρ∥z_{Y}∥₂²+λ∥z_{Y}−\hat{z}_{Y}∥₂² (8)

is a simplified version of Equation (4). This first term is a maximum likelihood estimate when training the INN as a normalizing flow. Since the affine layers are volume persevering, the log-absolute Jacobian term cancels.

The second term is the forward reconstruction loss

L_{y}(Ŷ,Y)=α∥Y−Ŷ∥₂². (9)

The final term includes additional regularizers to encourage bidirectional robustness:

$${L}_{r e g} ( θ , z , X , z ) = \frac{β}{ϵ} {‖ {F}^{- 1} ( z ) - {F}^{- 1} ( z + v ϵ ) ‖}_{2}^{2} + \frac{{β}^{′}}{ϵ} {‖ F ( [ θ ; {z}_{X} ] ) - F ( [ θ ; {z}_{X} ] + {v}^{′} ϵ ) ‖}_{2}^{2} + λ M M D ( \hat{θ} , θ ) \qquad ( 10 )$$

New samples may be drawn for z for calculating L_{reg}. λ may be annealed during training.

Here, v and v′ are samples from a diagonal Gaussian distribution normalized to have unit length, ϵ is a fixed scaling factor, and F is the proposed INN 222. The mappings of X↔[Z, Y] may be reused for calculation. This loss has been proposed as a means to improve generalization and stability of INNs. During training, small Gaussian noise may be added to θ before concatenating with z_{X} inputs which helps with learning. The final term is the maximum mean discrepancy (MMD) which encourages the INN 222 to have meaningful samples for the full prior distribution. During each update, new samples z may be drawn from the distribution and anneal the importance of the MMD term during training.

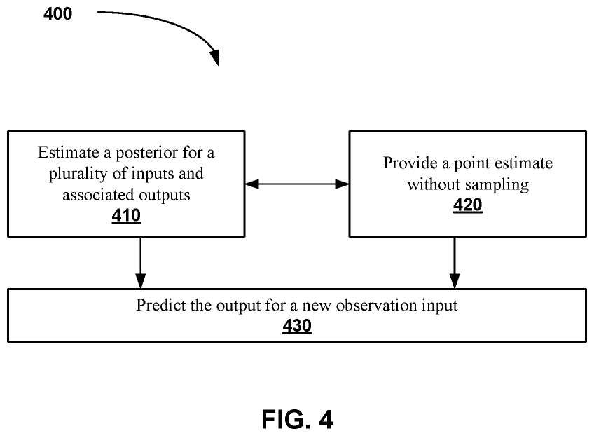

FIG. 4 illustrates, in a flowchart, an example of a method of predicting an output for an input 400, in accordance with some embodiments. The method 400 comprises at least one of estimating a posterior for a plurality of inputs and associated outputs 410, or providing a point estimate without sampling 420. It should be noted that steps 410 and 420 may be repeated and performed in any order. Once at least one of steps 410 or 420 are performed, then the output for a new observation input may be predicted 430 based on the estimated posterior and/or the point estimate without sampling. Other steps may be added to the method 400.

In some embodiments, estimating the posterior comprises training the INN model to learn a relationship between the plurality of inputs and the associated outputs. In some embodiments, estimating the posterior comprises sampling a latent variable Z, combining the plurality of inputs with Z, and applying the combined Z through the INN to determine the relationship between the plurality of inputs and the associated outputs. In some embodiments, the latent variable Z is sampled many times, the plurality of inputs are combined with each sample of the latent variable Z, each combined Z is applied through the INN, and a forward function and a corresponding inverse function result from the application of each combined Z through the INN, the forward function and the corresponding inverse function representing the relationship between the plurality of inputs and the associated outputs.

In some embodiments, providing the point estimate comprises selecting the latent variable Z to be 0, and applying an inverse function.

In some embodiments, predicting the output for the new observation comprises applying at least one of the estimated posterior or the point estimate to the new observation.

### Use Case Example

The machine learning prediction platform 200 and framework 300 may be used to make predictions. For example, when a series of X input data values leads to an observation of Y, the X input values maybe determined. For example, for a given temperature and location, an air quality index may be predicted.

It should be noted that the observation Y may include “noise” which may make the observation Y not accurate in the sense that it includes an unobservable parameter. Predictions made using the platform 200 and framework 300 may be able to determine X despite the uncertainty provided to the observation Y by the noise. There also be unobservable parameters in the model of X input data and Y observations. In capital markets, an example of an unobservable parameter may be called “volatility”.

The machine learning prediction platform 200 and framework 300 may be used to make predictions in capital markets. For example, a plurality of observed strike prices may be used as inputs X and observed option prices as corresponding outputs Y. The observed inputs may be input into input encoding unit 224, and the observed outputs may be input into the encoder 226. The INN 222 may then determine the inverse solution to determine the distribution conditioned on strike prices. Once model 228 is trained, a new observed strike price may be input into the input encoding unit 224 to determine the estimated option price. It should be noted that the nature of a relationship between X and Y is based on volatility. An observed option market price would actually be a true price plus noise or uncertainty. I.e., the amount of noise or uncertainty in an observed price will need to be handled by the trained model, This use case will be further described below.

### Related Work

INN Architectures and Theory. A typical choice in the literature for invertible layers is the affine coupling block. One work originally proposed a shift operation, and their later work included a scaling term along with several other layers specifically for image generation. Later works have since proposed improvements to affine coupling by sharing the hypernetworks for affine parameters. In the teaching herein, a volume-preserving affine version of the ReaINVP coupling layer was used, which have otherwise only been considered for lossless compression.

In recent years, more work has been done to improve efficiency of training, understand the learning capacity of INNs, and improve learning stability. Previous works have found that INNs can be modeled as ordinary differential equations leading to faster training. It has been previously suggested that to improve generalizability of INNs beyond training, regularization of training INNs in both the forward and inverse relation are necessary. INNS have been proven to be universal approximators both under zero-padding with additive coupling blocks, but can be universal without augmentation with affine couplings blocks as well. When augmenting the input dimensions of INNs, which has been shown to improve generative performance, special care is required for density estimation by using importance sampling to marginalize out the augmented variable distribution.

INN Applications. Much of the literature of INNs has moved towards conditional invertible neural networks (CINN), which are specialized INNs that model only the inverse problem by modelling observed outputs to each INNs layers hyper-network. It was originally proposed for conditional image generation, and has since been applied to solve problems in medical imaging and science. In the body of literature, the closest variation of CINNs to the present teachings is the Bayes flow model, which decreases uncertainty in predictions by encoding shared information between observed outputs via a summary network. Their work can be viewed as a particular sub-set to the problem described herein where only inverse parameters θ and observed outputs Y are relevant.

There is limited work in the understanding the applications of INN utility for modelling joint processes. One work proposed an architecture that was trained to predict both forward and inverse processes, but the authors only analyzed its application for inverse problems. A number of variants have since been proposed in benchmarking research, but predominantly all results still focus on solving inverse problems. Generative classifiers that incorporate an INN architecture are works that have largely focused on using the INN as a generator module on a shared latent space Z and have been used for robust classification.

Machine Learning in Finance. Financial model calibration is the term typically used in finance when solving the inverse problem of a financial model. Recent works have proposed replacing the calibration of a complex financial model by an ML-based approximation with the aim of retaining expressiveness while improving speed. The Calibration Neural Network (CaNN) is a data-drive approach which learns to predict option prices and uses an evolutionary optimization to calibrate a financial model. Other works have explored neural networks for calibrating volatility models, including stochastic volatility. One work discusses some limitations of the previous works, while proposing some improvements to calibration performance. However, none of these works describe above apply INNs to the task of calibration.

### Experiments

Experimental evaluations of the described financial models with invertible neural networks will now be described.

### Financial Derivatives

A derivative is a contract whose value at a future date (called the maturity) is defined as a function of an underlying asset (called the underlying). A classic example is a European equity call option with strike K. If S is the value of the underlying stock, then at maturity the option is worth max S−K, 0. Prior to maturity, the value of a derivative is its discounted expected payoff in the appropriate measure. This expectation depends on the stochastic process used to model the underlying asset. The financial literature refers to such stochastic processes as financial models. Financial derivative pricing models were chosen in this experiment because it is a real-world domain that fits the problem description. In finance, the θ refers to the underlying stochastic process parameters of the financial model. The X is defined as the contract parameters X=[S(0), K,T], and Y is the option price Y=V (S,T).

### Fixed Volatility Models

Assuming geometric Brownian motion dS=μS dt+σS dW, where μ, σ are constants and W is a Wiener process, V can be shown to follow the partial differential equation (PDE)

$$\frac{\partial V}{\partial t} + \frac{{σ}^{2} {S}^{2}}{2} \cdot \frac{{\partial }^{2} V}{\partial {S}^{2}} + rS \frac{\partial V}{\partial S} - rV = 0. \qquad ( 11 )$$

While Equation (11) has an analytical solution (see below), its higher-dimensional analogue V({Sᵢ}ᵢ, t) with multiple assets {Sᵢ}ᵢ and correlation matrix ρ between the Wiener processes {Wᵢ}ᵢ relies on expensive Monte-Carlo sampling.

### Stochastic Volatility Models (e.g., SABR)

Stochastic volatility models also model S using geometric Brownian motion but address the strong assumption of a fixed volatility through a separate stochastic process governing the volatility of S. Specifically, with geometric Brownian motion dS=μS dt+\sqrt{σ}S dW₁ and an Ornstein-Uhlenbeck process d\sqrt{σ}=−β\sqrt{σ}dt+δ dW₂, it can be shown that V(S, t, σ) follows the PDE

$$\frac{σ {S}^{2}}{2} \frac{{\partial }^{2} V}{\partial {S}^{2}} + \text{?} σ S \frac{{\partial }^{2} V}{\partial S \partial σ} + \frac{{η}^{2} σ}{2} \frac{{\partial }^{2} V}{\partial {σ}^{2}} + r S \frac{\partial V}{\partial S} + ( \text{?} ( θ - σ ) - λ ) \frac{\partial V}{\partial σ} - rV + \frac{\partial V}{\partial t} = 0 , \\ \text{?} \text{indicates text missing or illegible when filed} \qquad ( 12 )$$

where ρ is the correlation between the Wiener processes, λ(S, t, σ) is the price of volatility risk,

$$η = 2 δ , κ = 2 β , and θ = \frac{{δ}^{2}}{2 β} .$$

Similar to the introductory example, a European call option satisfies Equation (12) subject to a set of boundary conditions. Please see below for additional stochastic volatility models.

### Dataset Set-Up

In the evaluation, the proposed framework was evaluated on a number of financial models. To understand the affects on the posterior distribution for the inverse problem and forward prediction, the two dimensional Black Scholes model for call options and the Sabr model were considered. In both of these cases a dataset of one million training examples, 5000 examples for validation, and 5000 test examples were generated. The validation set is primarily used to monitor the affects of training models, particularly as small Gaussian noise was introduced on training examples which have been shown to help training performance. All metrics are reported on the test set.

To understand the posterior estimates of the models, a quantile rejection sampling approach was used to approximate the true posterior P(X|Y) with quantile set to q=0.0005 to generate 256 quality samples. The posterior dataset is of 256 examples, each with 256 associated samples each requiring approximately 500,000 samples each to meet the quantile criteria.

To demonstrate the proposed modifications in a more realistic setting, a dataset of the Merton model was generated using Monte Carlo sampling. This dataset consists of 1.5 million training examples and 5000 validation examples. The parameters of the Monte Carlo sampling were 100 discretization steps with 100,000 Monte Carlo paths.

### Datasets

The evaluation of the proposed system involved computational finance. The forward process is financial derivative pricing, and the inverse problem is referred to as model calibration. This domain is selected because it is an area where the proposed system has practical utility. Full discussion of the domain in provided below. In the setting, the data X=[S₀, K, τ] which correspond to the initial value of the underlying, strike price, and maturity of the option contract. The output observations are the payment Y=max(S_{τ}−K, 0). The inverse solutions θ vary between each financial model. The financial models evaluated on are the two dimensional Black Scholes Model (B. Scholes) (θ=[σ_{V}, σ_{H}, ρ]); Stochastic Alpha Beta Rho (SABR)(θ=[α, β, ρ, v]); and Merton's Jump Diffusion (Merton) (θ=[μ, v, λ]).

### Forward Prediction

The first experiment determines how well the proposed system performs when only attempting to predict the forward process. Results are shown in Table 1 comparing models using the R-squared (R2) metric vs the normalized root-mean-square error (NRMSE) metric. Generally it was found that compared to baselines the proposed models (FWDBWD and FWDBWD-Zero) does not have notably worse predictions across all models. It should be noted that zero padding seemed to be a worse augmentation approach in the proposed model compared to the feature embedding zₓ for forward prediction.

TABLE 1
The forward prediction accuracy of the proposed model
when the ground truth θ* is known.

| | | R2 | | | NRMSE | |
|---|---|---|---|---|---|---|
| | B. Scholes | SABR | Merton | B. Scholes | SABR | Merton |
| FWDBWD | 0.825 ± 0.004 | 0.834 ± 0.005 | 0.969 ± 0.001 | 0.045 ± 0.001 | 0.021 ± 0.000 | 0.021 ± 0.000 |
| FBDBWD- | 0.818 ± 0.007 | 0.821 ± 0.009 | 0.969 ± 0.001 | 0.046 ± 0.001 | 0.022 ± 0.001 | 0.021 ± 0.001 |
| Zero | | | | | | |
| Seq2Seq | 0.842 ± 0.003 | 0.829 ± 0.007 | 0.973 ± 0.001 | 0.046 ± 0.000 | 0.021 ± 0.000 | 0.020 ± 0.000 |
| INN-Seq2Seq | 0.841 ± 0.003 | 0.847 ± 0.005 | 0.975 ± 0.001 | 0.046 ± 0.000 | 0.020 ± 0.000 | 0.019 ± 0.000 |
| INN-Seq2Seq- | 0.765 ± 0.008 | 0.803 ± 0.008 | 0.972 ± 0.001 | 0.056 ± 0.001 | 0.023 ± 0.000 | 0.020 ± 0.000 |
| zero | | | | | | |

The trade-off of the model for forward prediction and in the use case will now be determined. These experiments do not use the ground truth models for forward prediction, and are strictly about the efficacy of training approximate models for the task. The purpose of these experiments is to determine, under similar training settings, the potential loss or gain in performance in joint training. The model is compared to several variations of sequence-to-sequence models as well as a simple multi-layer perceptron. Sequence-to-sequence models are compared because the proposed framework includes them for predicting several associate assets. Two variations are considered: one which directly concatenates the model parameters at each step of prediction, and one where the INN layers are included as before but only train the model for forward prediction. The RNN components all have a similar number of parameters otherwise.

Having demonstrate the trade-offs with the proposed framework, results when using inferred solutions under the model for predicting the evaluation of new data are presented. Here, an alternative approach is compared where directly learning is not used.

The experiments demonstrate the potential trade-offs of a system trained end-to-end for simultaneously estimating the inverse posterior distribution and then making forward predictions. The experiments use the observed pay-offs as the observation output. More specific to finance, it has been found that it can be better to instead work in the domain of implied volatility due to ambiguity in the interpretations of the pay-off.

### Comparing Posterior Distributions

In this experiment, the focus was solely on the proposed model's capacity to approximate the inverse posterior distribution. Here, the uncertainty is in the potential finance model parameters that could explain the predicted implied volatility or payment. Table 2 shows results on the test set posterior distributions results. Description of the metrics are below.

TABLE 2
Performance Comparisons of Posteriors across metrics on the distributions wholistically.

| | | | | | | | Average Expected | | |
|---|---|---|---|---|---|---|---|---|---|
| | | MMD | | | MAP | | Reprojection | | |
| | B.Scholes | SABR | Merton | B.Scholes | SABR | Merton | B.Scholes | SABR | Merton |
| FWDBWD | 0.161 ± | 0.062 ± | 0.074 ± | 11.702 ± | 0.356 ± | 0.087 ± | 11.702 ± | 0.422 ± | 0.142 ± |
| | 0.081 | 0.031 | 0.068 | 0.068 | 0.171 | 0.046 | 0.523 | 0.073 | 0.028 |
| FWDBWD- | 0.129 ± | 0.086 ± | 0.089 ± | 9.667 ± | 0.267 ± | 0.072 ± | 11.693 ± | 0.370 ± | 0.115 ± |
| zero | 0.045 | 0.034 | 0.062 | 0.829 | 0.083 | 0.035 | 0.902 | 0.034 | 0.014 |
| CINN | 0.038 ± | 0.020 ± | 0.024 ± | 2.336 ± | 0.070 ± | 0.017 ± | 9.363 ± | 0.687 ± | 0.254 ± |
| | 0.001 | 0.001 | 0.002 | 0.175 | 0.010 | 0.007 | 0.152 | 0.037 | 0.007 |
| CVAE | 0.068 ± | 0.027 ± | 0.013 ± | 8.209 ± | 0.068 ± | 0.009 ± | 11.983 ± | 0.829 ± | 0.027 ± |
| | 0.003 | 0.002 | 0.001 | 0.455 | 0.003 | 0.001 | 0.390 | 0.091 | 0.002 |

The posterior distributions learned by the proposed model will now be compared to models trained strictly for estimating the inverse posterior distribution. The conditional invertible neural network and the conditional variational autoencoder were chosen as baselines. The CiNN is the state-of-the-art as a means of estimating inverse posterior distributions, where as the C-VAE has previously been less effective, and demonstrates that the problems are non-trivial to model with just any naive alternative. To evaluate the posteriors, 128 posterior distributions were generated per financial model with quantile rejection sampling with 256 accepted samples and a quantile of q=0.0005.

### Inverse Prediction to Forward Prediction

To demonstrate the trade-offs of the proposed framework, the end-to-end system was considered. In this experiment, 1000 testing examples were generated with 20 associated data points for each θ on each of the three datasets. Each datum was separated into two sets of 10. One set is for generating an inverse solution \hat{θ}. With this inverse solution, the other data set is then passed through the model with the found MAP inverse solution. An increasing number of data points are added to determine whether the proposed system becomes more accurate with the included data.

As baselines, separately trained systems are taken and the solutions from the inverse posterior models (CINN and CVAE) are used, and they are passed to the Sequence to Sequence (Seq2Seq) baselines which use the predicted inverse solution directly in place of the ground truth θ.

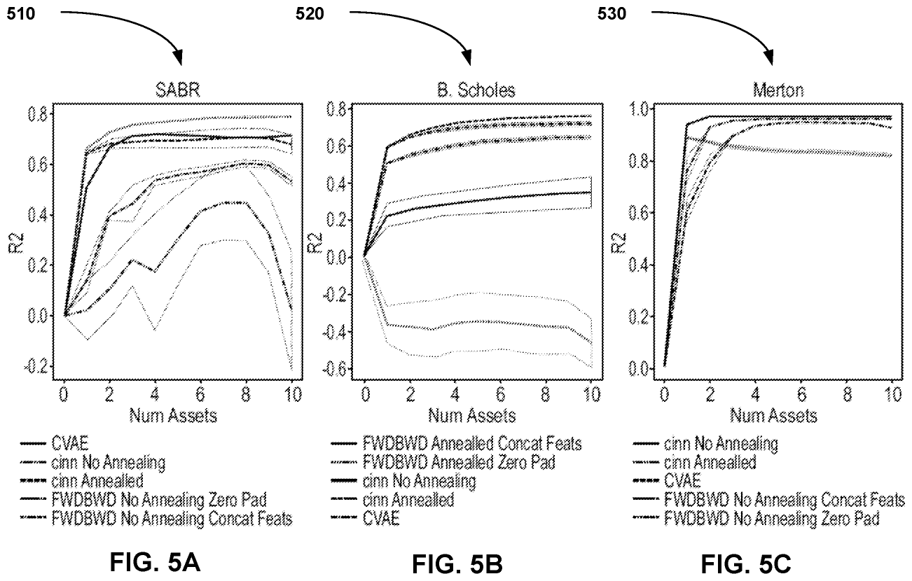

FIGS. 5A to 5C illustrate, in graphs 510, 520, 530, a change in R2 metric as more data is collected for the proposed INN system (FWDBWD Annealled Concat Feats and FWDBWD Annealled Zero Pad) compared to baselines, in accordance with some embodiments. The change in performance of the R2 solution is shown with the baselines and best performing versions of the proposed INN system (FWDBWD Annealled Concat Feats and FWDBWD Annealled Zero Pad) on a validation set. For nearly all models, it is seen that the forward predictive performance improves as more data is included to find the inverse solution. Results for some models include a distribution. Such distributions are shown having upper and lower limits plotted using thinner lines while the average values are plotted using thicker lines.

### Additional Information on Datasets

In this section, information describing each of the financial models used in the experiments are provided. This includes equations describing the dataset along with tables listening the distributions sampled from to produce the training, validation, and test datasets. Notationally, U(•,•) for a Uniform distribution, Cat(•,•) for a Categorical distribution of equal probability, and LogNormal(•,•) for a log-Normal distribution, are used.

### 2D Black Scholes

The following are examples of Black Scholes inputs:
H, V: Value of the asset
K: exercise price (F above)
r: instant rate of interest
σ_{V}, σₕ: instantaneous variance of expected return
ρᵥₕ: correlation of underlying weiner processes
τ: time to maturity T−t

The analytic black scholes formula in a the 2D case for a European call option can be written as follows:

$$M = {HN}_{2} ( {γ}_{1} + σ H \sqrt{r} , \frac{ln ( \frac{V}{H} ) - 0.5 {σ}^{2} \sqrt{τ}}{σ \sqrt{τ}} , \frac{{ρ}_{vh} {σ}_{V} - {σ}_{H}}{σ} ) + {VN}_{2} ( \text{} {γ}_{2} + {σ}_{V} \sqrt{τ} , \frac{ln ( \frac{V}{H} ) - 0.5 {σ}^{2} \sqrt{τ}}{σ \sqrt{τ}} , \frac{{ρ}_{vh} {σ}_{H} - {σ}_{V}}{σ} ) - \text{?} \text{?} {N}_{2} ( {γ}_{1} , {γ}_{2} , {ρ}_{vh} ) \\ \text{?} \text{indicates text missing or illegible when filed} \qquad ( 13 )$$

where N₂(α;β;θ) represents the bivariate cumulative standard normal distribution with upper limits of integratph α, β and coefficient of correlation θ. Where

γ₁=(ln(H/K)+(r−0.5*σₕ²)τ)/σₕ\sqrt{τ},

γ₂=(ln(V/K)+(r−0.5*σ_{V}²)τ)/σ_{V}\sqrt{τ},

σ²=σ_{V}²+σ_{H}²−2ρ_{V H}σ_{V}σ_{H}.

### On the Bivariate Normal

The standard bivariate normal pdf is defined as follows:

$$\frac{1}{2 π \sqrt{1 - {ρ}^{2}}} exp ( - \frac{1}{2 ( 1 - {ρ}^{2}} [ {x}^{2} - 2 ρ xy + {y}^{2} ] ) \qquad ( 14 )$$

The cumulative distribution function is a special case of the multivariate Gaussian. If the above can be written as a multivariate gaussian, an existing libraries implementation of the multivariate gaussian may be used instead. I.e., a symmetric Σ matrix is defined as a symmetric matrix with ρ as the off diagonals and ones on the diagonals.

### Stochastic Alpha Beta Rho

The stochastic alpha beta rho (SABR) model.

TABLE 3
Sampling values for the 2D Black-Scholes model for experiments

| Variable | Sampling Distribution |
|---|---|
| H | 100LogNormal(0.5, 0.25) |
| V | 100LogNormal(0.5, 0.25) |
| σ_{H} | U(1e−5, 1.0) |
| σᵥ | U(1e−5, 1.0) |
| τ | Cat(1, 43) * 2/365 |
| S | Min(H, V) |
| K | [(S0.5-S1.5) U(0, 1)] + S1.5 |
| P | U(−0.999, 0.999) |

TABLE 4
Sampling values for the SABR model for experiments

| Variable | Sampling Distribution |
|---|---|
| S | 100LogNormal(0.5, 0.25) |
| A | U(1e−5, 1.0) |
| B | U(0, 1.0) |
| P | U(−0.90, 0.90) |
| V | U(0.10, 8.33) |
| τ | Cat(1, 43) * 2/365 |
| K | [(S0.5-S1.5) U(0, 1)] + S1.5 |

TABLE 5
Merton Jump Diffusion Model Parameters

| Variable | Sampling Distribution |
|---|---|
| S | 100LogNormal(0.5, 0.25) |
| Σ | U(1e−5, 1.0) |
| M | U(0, 0.4) |
| V² | U(0.0, 0.3) |
| ∧ | U(0.0, 3.0) |
| τ | Cat(1, 730) * 1/365 |
| K | {[}(S0.5-S1.5) U(0, 1X){]} + S1.5 |

### Merton Jump Diffusion

A simple form of Merton Jump Diffusion may be used. Jump diffusion models attempt to model the discontinuities observed in the stock market. This is achieved by including a jump process in the gemotric Brownian Motion previously discussed. Typically this jump distribution is modelled as a compound Poisson Process. The stochastic differential equations just includes an additional jump term

$$ln \frac{S}{{S}_{T}} + {\int }_{0}^{i} ( r - \frac{{σ}^{2}}{2} ) dt + {\int }_{0}^{i} σ dW ( t ) + {\sum }_{j = 1}^{{N}_{i}} ( {Q}_{j} - 1 ) = 0$$

where here N(t) is a the previously mentioned Poison Process with a probability of k jumps occurring, and Qⱼ is a log-normally distributed random variable. Jump diffusion models provide an alternative means of explaining the volatility smile.

### Heston Model

Hyperparameter space:

$$\frac{1}{2} \text{?} {S}^{2} \frac{{\partial }^{2} V}{\partial {S}^{2}} + \frac{1}{2} {γ}^{2} \text{?} \frac{{δ}^{2} V}{δ \text{?}} + \frac{δ V}{δ t} + rS \frac{δ V}{δ S} + k ( \text{?} - \text{?} ) \frac{δ V}{δ \text{?}} + ρ γ S \text{?} - rV = 0 , \\ \text{?} \text{indicates text missing or illegible when filed} \qquad ( 15 )$$

### Baselines

A detailed description of the baselines for each experiment will now be described.

TABLE 6
Merton Jump Diffusion Model Parameter

| Variable | Sampling Distribution |
|---|---|
| S | 100LogNormal(0.5, 0.25) |
| Z | U(1e−5, 1.0) |
| M | U(0, 0.4) |
| V² | U(0.0, 0.3) |
| ∧ | U(0.0, 3.0) |
| τ | Cat(1, 730) * 1/365 |
| K | {Q(S0.5-S1.5) U(0,1){]} + S1.5 |

TABLE 7
Heston model. Classic Latin Hypercube Sampling approach
used to sample and spaces passed to sampler together

| Variable | Sampling Distribution |
|---|---|
| S₀ | LHS(0.6, 1.4) |
| τ | LHS(0.05, 3.0) |
| risk free rate r | LHS(0.0, 0.05) |
| correlation ρ | LHS(−0.90, 0.0) |
| reversion speed k | LHS(0.0, 3.0) |
| Volatility of volatility γ | LHS(0.01, 0.5) |
| long average volatility v | LHS(0.01, 0.5) |
| initial variance v₀ | LHS(0.5, 0.5) |

### Posterior Approximation Baselines

CINN Both baselines use a summary network that is a bidirectional gated recurrent unit (GRU), with a hidden size of 32 for an embedding of 64 dimensions.

The CVAE uses four hidden layers with Leaky ReLU activation of size 128 in the encoder and decoder. The CINN has 4 coupling blocks which have two hyper-networks each to predict the corresponding scale and shift parameters for that layer in the affine layer.

### Forward Prediction Baselines

Encoder Decoder with Inverse solution. In this model, a sequence to sequence model is used with a generator network. The input's X are encoded with a bi-directional gated recurrent unit (GRU) where each GRU's hidden state is 16 dimensions for an embedding of 32 dimensions −(X). During decoding, the inverse solution θ is concatenated with this embedding for decoding. This concatenated embedding is then converted to the appropriate dimensions of the decoder's hidden state via single layer multi-layer perceptron with tanh activations. For each step of decoding, the concatenated embedding is appended to the hidden state of the decoder GRU unit and passed through a generator neural network to predict the price per asset. This generator network is a two hidden layer multi-layer perceptron with tanh activation functions that outputs the price of an asset in the sequence.

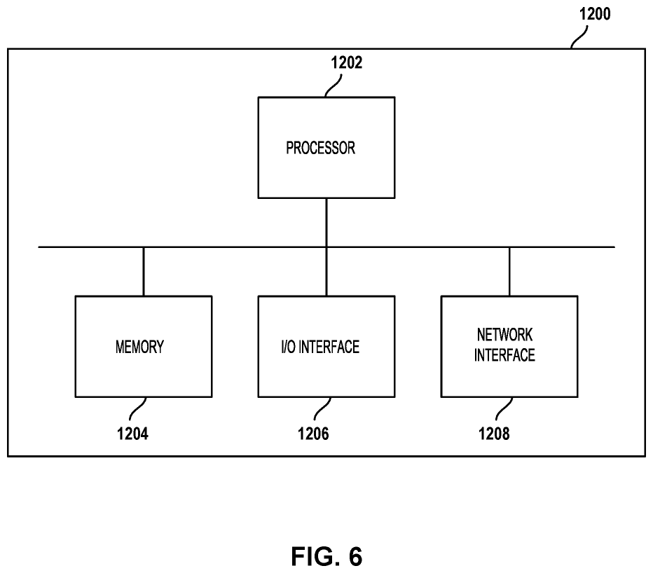

FIG. 6 is a schematic diagram of a computing device 1200 such as a server. As depicted, the computing device includes at least one processor 1202, memory 1204, at least one I/O interface 1206, and at least one network interface 1208.

Processor 1202 may be an Intel or AMD x86 or x64, PowerPC, ARM processor, or the like. Memory 1204 may include a suitable combination of computer memory that is located either internally or externally such as, for example, random-access memory (RAM), read-only memory (ROM), compact disc read-only memory (CDROM).

Each I/O interface 1206 enables computing device 1200 to interconnect with one or more input devices, such as a keyboard, mouse, camera, touch screen and a microphone, or with one or more output devices such as a display screen and a speaker.

Each network interface 1208 enables computing device 1200 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

The discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A system for predicting an output for an input, the system comprising:
at least one processor; and
a memory comprising instructions which, when executed by the processor, configure the processor to:
at least one of:
estimate a posterior for a plurality of inputs and associated outputs; or
provide a point estimate without sampling; and
predict the output for a new observation input.

2. The system as claimed in claim 1, wherein to estimate the posterior, the processor is configured to:
train an invertible neural network (INN) model to learn a relationship between the plurality of inputs and the associated outputs.

3. The system as claimed in claim 2, wherein to estimate the posterior, the processor is configured to:
include a latent variable Z of dimension s_{Z}; and
include the plurality of inputs as conditional information to each affine coupling layer.

4. The system as claimed in claim 3, wherein to estimate the posterior, the processor is configured to:
sample the latent variable Z;
combine the plurality of inputs with Z; and
apply the combined Z through the INN to determine the relationship between the plurality of inputs and the associated outputs.

5. The system as claimed in claim 4, wherein:
the latent variable Z is sampled many times;
the plurality of inputs are combined with each sample of the latent variable Z;
each combined Z is applied through the INN; and
a forward function and a corresponding inverse function result from the application of each combined Z through the INN, the forward function and the corresponding inverse function representing the relationship between the plurality of inputs and the associated outputs.

6. The system as claimed in claim 1, wherein to provide the point estimate, the processor is configured to:
select Z to be 0; and
apply an inverse function.

7. The system as claimed in claim 1, wherein to provide the point estimate, the processor is configured to:
determine a maximum a posterior estimate by applying a transformation to a point of maximum density of a base distribution; and
subtract an arithmetic mean of a scaling parameter.

8. The system as claimed in claim 1, wherein to predict the output for the new observation, the processor is configured to:
apply at least one of the estimated posterior or the point estimate to the new observation.

9. The system as claimed in claim 1, comprising an invertible neural network configured to:
receive the plurality of inputs;
determine the plurality of associated outputs;
send the plurality of associated outputs to an encoder;
receive the latent variable Z from the encoder; and
determine an inverse solution.

10. A method of predicting an output for an input, the method comprising:
at least one of:
estimating a posterior for a plurality of inputs and associated outputs; or
providing a point estimate without sampling; and
predicting the output for a new observation input.

11. The method as claimed in claim 10, wherein estimating the posterior comprises:
training an invertible neural network (INN) model to learn a relationship between the plurality of inputs and the associated outputs.

12. The method as claimed in claim 11, wherein estimating the posterior comprises:
including a latent variable Z of dimension s_{Z}; and
including the plurality of inputs as conditional information to each affine coupling layer.

13. The method as claimed in claim 12, wherein estimating the posterior comprises:
sampling the latent variable Z;
combining the plurality of inputs with Z; and
applying the combined Z through the INN to determine the relationship between the plurality of inputs and the associated outputs.

14. The method as claimed in claim 13, wherein:
the latent variable Z is sampled many times;
the plurality of inputs are combined with each sample of the latent variable Z;
each combined Z is applied through the INN; and
a forward function and a corresponding inverse function result from the application of each combined Z through the INN, the forward function and the corresponding inverse function representing the relationship between the plurality of inputs and the associated outputs.

15. The method as claimed in claim 10, wherein providing the point estimate comprises:
selecting Z to be 0; and
applying an inverse function.

16. The method as claimed in claim 10, wherein providing the point estimate comprises:
determining a maximum a posterior estimate by applying a transformation to a point of maximum density of a base distribution; and
subtracting an arithmetic mean of a scaling parameter.

17. The method as claimed in claim 10, wherein predicting the output for the new observation comprises:
applying at least one of the estimated posterior or the point estimate to the new observation.

18. The method as claimed in claim 10, comprising:
receiving, at an invertible neural network (INN), the plurality of inputs;
determining, at the INN, the plurality of associated outputs;
sending, from the INN, the plurality of associated outputs to an encoder;
receiving, at the INN, the latent variable Z from the encoder; and
determining, at the INN, an inverse solution.

19. A computer readable medium having a non-transitory memory storing a set of instructions which, when executed by a processor, configure the processor to:
at least one of:
estimate a posterior for a plurality of inputs and associated outputs; or
provide a point estimate without sampling; and
predict the output for a new observation input.

20. The computer readable medium as claimed in claim 19, wherein:
to estimate a posterior, the processor is configured to:
sample a latent variable Z several times;
combine the plurality of inputs with each sampled Z;
apply each combined Z through the INN to determine the relationship between the plurality of inputs and the associated outputs; and
a forward function and a corresponding inverse function result from the application of each combined Z through the INN, the forward function and the corresponding inverse function representing the relationship between the plurality of inputs and the associated outputs;
to provide the point estimate, the processor is configured to:
select Z to be 0; and
apply an inverse function; and
to predict the output for the new observation, the processor is configured to:
apply at least one of the estimated posterior or the point estimate to the new observation.
